(19) United States
(12) Patent Application Publication
(10) Pub. No.: US 2010/0190924 A1
(43) Pub. Date: Jul. 29, 2010

(54) POLYMER COMPOSITES AND METHODS FOR PRODUCING THE SAME

(75) Inventor: Sanghoon Kim, Peoria, IL (US)

Correspondence Address: Perkins Coie LLP, 607 Fourteenth Street, NW, Washington, DC, 20005, US

(73) Assignee: UNITED STATES DEPARTMENT OF AGRICULTURE, PEORIA (IL)

(21) Appl. No.: 12/670,922

(22) PCT Filed: Jun. 30, 2008
(86) PCT No.: PCT/US08/68711

§ 371 Date: Mar. 22, 2010

(30) Foreign Application Priority Data
Jun. 28, 2007 (US) 60946783

(51) Int. Cl. C08L 3/02

(52) U.S. Cl. 524/716

(57) ABSTRACT

This invention relates to electrically conductive and non-conductive polymer composite materials suitable for use as polymer composites, electrically conductive materials, electromagnetic wave shielding materials, heating elements, antistatic materials, substitute for existing polymer composites, and the like. The invention also relates to methods of making the electrically conductive and non-conductive polymer composite materials, and compositions containing the polymer composites also are disclosed herein.

This application claims priority to U.S. Ser. No. 60/946,783 filed on Jun. 28, 2007, the entirety of which is hereby incorporated by reference.

The present invention was made with government support under Grant Agreement No. 58-3K95-6-1140 awarded by the United States Department of Agriculture. The U.S. government has certain rights in this invention.

### FIELD OF THE INVENTION

This invention relates to electrically conductive and non-conductive polymer composite materials suitable for use in polymer composites. Such polymers can be used in, for example, electrically conductive materials, electromagnetic wave shielding materials, heating elements, antistatic materials, is substitutes for existing polymer composites, and the like. The invention also relates to methods of making the electrically conductive and non-conductive polymer composite materials.

### BACKGROUND OF THE INVENTION

Plastic materials are encroaching on the usage and the market of conventional materials like metal or ceramic materials due to increasing demands for light, flexible, sophisticated, and multifunctional materials. A key property of the most polymers which distinguishes them from metals, in general, is their inability to carry electricity, and thus are generally used as insulators. Nonetheless, researchers have sought how to prepare plastic materials with electrical conductivity in an effort to develop plastic conductors or semiconductors having the advantageous properties of plastics. Attempts have been made to create plastic materials having electrical conductivity, while retaining advantageous properties of plastic, since the first discovery of the metallic conductivity in iodine or bromide doped free-standing films of polyacetylene by A. J. Heeger, A. G. MacDiarmid, and H. Shirakawa in 1977 (see Shirakawa, H. et al., J.C.S., Chem. Commun. 1977, p. 578).

Although intrinsically conductive polymers can have functional properties such as electrochromism, light emission, transparency, super conductivity, thermochromism, metallic properties, catalytic properties, electromechanical actuation, solvatochromism, and nonlinear optic properties, the stiffness of the backbone structure of other polymers limit the fabrication of the polymer into articles with desired mechanical properties. The electrical conductivity and moldability of the intrinsically conducting polymer lack application of these materials in the field, which require high conductivity and high volume of the conductive polymer.

Other attempts to create conductive polymeric materials was to produce conductive polymer composites or blends by mixing the polymeric materials with electrically conductive materials such as graphite powder, carbon black powder, metallic powder, or intrinsically conducting powder. There has been considerable interest in developing conductive polymer composites based on insulating polymer matrices and electrically conductive fillers, such as carbon black (CB), carbon nanotubes (CN), graphite, metal powders, and semiconductor powders, in an effort to apply these product to produce polymer conductors, semi-conductors, self-regulated heating, positive temperature coefficient (PTC) materials, electromagnetic shielding materials, actuators, electronic device components, antistatic materials, conductive adhesives, and chemical vapor sensors, for example. U.S. Pat. No. 5,958,303, U.S. Pat. No. 6,059,997, U.S. Pat. No. 6,277,303, U.S. Pat. No. 6,927,250, U.S. Pat. No. 4,199,628, and U.S. Pat. No. 6,757,154, relate to various conductive polymer composites using conductive particles as fillers and polymer matrix as binders.

Poly(alkyl cyanoacrylate) (PACA) is a degradable polymer. Degradation of alkyl cyanoacrylates polymers follows two pathways, hydrolytic polymer side alkyl chain scission and enzymatic ester hydrolysis. Initially, it was believed that only the first degradation pathway existed (Leonard et al., J. Appl. Polym. 10:259-272, 1966). Then, Wade and Leonard (J. Biomed. Mat. Res. 6:215, 1972) observed in vivo, after the implantation of a PACA polymer block, a contribution in the degradation mechanism by enzymatic ester hydrolysis, and concluded that both pathways were involved in PACA degradation. Later Lenaerts et al. (Biomaterials, 5:65-68, 1984), investigating the degradation of PACA nanoparticles, found that the major pathway for the degradation of polymer particles was the cleavage of the side chain ester bond. Morphologically, the degradation of PACA nanoparticles was found to be a surface erosion process (Muller et al., Biomaterials, 11:590-595, 1990). Also, Tuncel et al. (J. Biomed. Materials Res, 29:721-728, 1995) who observed particle degradation in phosphate buffer solution by electron microscopy, concluded that particle degradation occur mainly by surface erosion.

Alkyl-2-cyanoacrylates, usually the product of condensation of formaldehyde with cyanoacetate, are low viscosity liquids with excellent wetting properties. Alkyl-2-cyanoacrylates undergo spontaneous anionic polymerization at room temperature by anionic active species, such as weak bases including moisture and alcohol, amines, phosphines, and alkaline materials, due to the unique electron withdrawing properties of nitrile and carboxyalte groups substituted on carbon 2. In addition to the ability to polymerize rapidly (at room temperature in absence of a catalyst) and good wetting property, the high polarity and high bond strength between various adherents make the property of the alky-2-cyanoacrylate unique. As a result, the Alkyl-2-cyanoacrylates have wide range of application including instantaneous adhesives for rubbers, plastics, metals, glass and the like, and are known as “super glue.” Alkyl-2-cyanoacrylates also have been used as a tissue adhesives for the skin wound and a surgical glue due to their bonding properties with most polar substrates, including living tissues and skin and biocompatible properties. Recently, PACA has been used for polymer colloidal drug delivery system, especially for cancer treatment and intracellular infections.

Although alkyl-2-cyanoacrylates are commonly polymerized by anionic polymerization, they also can be prepared by free radical polymerization methods. The resulting poly (alkyl-2-cyanoacrylates) are basically hard, colorless, and amorphous polymers. Physical properties of these polymers are variable, dependent on the size of the alkyl substituent, molecular weight, polymerization conditions and methods, and contaminants. However, the use of cyanoacrylate polymer as conventional plastic materials has been seldom studied. This may be due to the fact that retropolymerization reaction or degradation at elevated temperatures restricts the use of this polymer where prolonged service temperature is below 100° C. Furthermore, there is no report on the polymer composites using cyanoacrylate, although its fast, easy polymerization and relatively good mechanical properties should allow for facile production of polymer composites (see Kung et al., Macromolecules, 33:8192-8199, 2000).

Alkyl cyanoacrylate is a major component of a well-known adhesive, “super glue”, that was introduced in the early 1970s. The preparation of alkyl cyanoacrylate esters was first reported by scientists at B. F. Goodrich in 1949 (U.S. Pat. No. 2,467,926), and these monomers were observed to produce hard, glassy polymers after thermal polymerization (Ardis, 1949, U.S. Pat. No. 2,467,926). Alkyl cyanoacrylate esters could effectively perform as one-part liquid adhesives, which would cure rapidly at room temperature. Unlike epoxy or acrylic adhesives, alkyl cyanoacrylate adhesives polymerizes, in many cases, without the need for an added initiator or curing agent. The first cyanoacrylate instant adhesive, Eastman 910, which utilized methyl cyanoacrylate as the monomer, was marketed in 1958. Because of the cyanoacrylates' ability to bond a wide variety of substrates, cyanoacrylate instant adhesives are now produced in multi-ton quantities for both industrial and consumer applications.

Of the aforementioned conductive filler particles for creating conducting composite materials, graphite has outstanding electrical and thermal conductivity. Graphite is an all carbon material which has a layered structure consisting of stacked sheets in which the carbon atoms are linked in a hexagonal framework with sp² bonding. Conventional graphite particles are usually powders with particle diameter in micron size. Although graphite, which is naturally abundant, has a good electrical conductivity, acceptable corrosion resistance, and high thermal conductivity, the poor mechanical properties such as brittleness and easy cleave limit the application of graphite. In order to improve the properties of pure graphite, polymer composites have long been investigated. In particular, graphite-filled polymer composites have been utilized in the field of conducting, aerospace, and electrochemistry due to its electrical conductivity, antistatic properties as well as good thermal properties.

However, the field has not recognized, among other things, the possibilities of using cyanoacylate as a polymeric matrix for creating polymer composites, especially for the matrix of conductive polymer composites. Therefore, polymer composites having combined rapid and easy anionic polymerization nature as well as several functional properties of the cyanoacrylate monomer with proper particulate materials to produce facile, robust, and multifunctional composite materials were not known until the present invention. More specifically, the invention provides novel and inventive methods and materials to produce electrically conductive and non-conductive polymer composites to satisfy long felt unmet needs and succeeded where others have failed, as discussed above.

### SUMMARY OF THE INVENTION

The present invention provides methods to produce electrically conductive and non-conductive polymer composites, as well as the composition. Non-conductive composite comprises starch and cyanoacrylate. The electrically conductive polymer composite according to the invention further comprises conductive filler materials, such as graphite, dispersed in the aforementioned non-conductive composite material in an amount sufficient to form a continuous chain structure. When mixed with starch, cyanoacrylate monomers begin polymerization as initiators are supplied from the surface of starch granules to form a non-conducting polymer composites. Inclusion of conductive fillers such as graphite to the reaction mixture imparts conductance to the product. Conductance can be adjusted by varying the percentage of conductive filler. The produced polymer composite has excellent mechanical properties and high electrical conductivity. Therefore, the polymer composites of the invention are suitable for use as electrically conductive material, electromagnetic wave shielding material, heating element, antistatic material, and the like.

The present invention also provides the method and composition for producing novel biodegradable polymer composites and conducting polymer composites produced by incorporating graphite as a conductive filler in the biodegradable polymer composite matrix.

Cyanoacrylate monomers readily polymerize at room temperature when initiators are mixed with them. The optimum weight percent of starch is in the range of 50-65%. When a fraction of starch is replaced with a conductive filler such as graphite, the resulting product turns into a conducting polymer composite. By varying the amount of conductive filler, the conductance of the final product can be controlled.

The present invention provides rapid, facile and low-cost methods for making conductive and non-conductive polymer composites, wherein the polymer composites are manufactured by in situ polymerization at room temperature. Within a short period time (preferentially for example, less than 10 minutes) after being administered, the composition forms a network that develops with high strength and functional (for example, electrically conductive) composites. The methods do not require heating or a catalyst to yield the final product. The resulting composites can be molded into any shape and/or size and exhibits excellent mechanical properties.

According to one aspect, the invention provides methods for making polymer composites from cyanoacrylate monomers and starches as filler by in situ polymerization. In another aspect, the invention provides methods for making conducting polymer composites from using the polymerized cyanoacrylate-starch polymer composites as a matrix.

According to another aspect, the invention provides conducting polymer composites comprising a conducting filler material dispersed in the matrix material in an amount which is at or just exceeds the percolation threshold and sufficient to generate a continuous conducting network in the minor phase material. In another aspect, the conducting filler can be selected from the group consisting of an electro-conductive fillers such as graphite, carbon black, carbon fiber, and carbon nanofiber, carbon nanotubes, intrinsically conducting polymers, and mixtures thereof.

According to another aspect, the invention provides methods for controlling reaction time for in-situ polymerization reaction in each mixture so as to provide a suitable time for forming polymer composites.

In one embodiment, the invention provides composition for molding the polymer composites described herein. In another embodiment, the invention provides composition of the conducting polymer composites described herein.

One aspect of the invention provides methods of making a polymer composites comprising: a) mixing alkyl-cyanoacrylate molecules (for example, monomers, including methyl-cyanoacrylate, ethyl-cyanoacrylate, propyl-cyanoacrylate, butyl-cyanoacrylate, hexyl-cyanoacrylate, and octyl-cyanoacrylate) and with one or more starch, wherein the starch is a filler; and b) allowing in situ polymerization of the mixture, thereby forming a polymer composite.

In another aspect, the invention provides methods of making conducting polymer composites comprising a base matrix, wherein the matrix is a polymer composite made according to the methods described above.

Another aspect of the invention provides conducting polymer composites comprising a conducting filler material dispersed in a matrix material in an amount, which is at about or just exceeds the percolation threshold, and sufficient to generate a continuous conducting network in the minor phase material.

Another aspect of the invention provides conducting polymer composites, as described above, wherein the conducting filler is an electro-conductive fillers selected from the group consisting of graphite, carbon black, carbon fiber, carbon nanofiber, carbon nanotubes, intrinsically conducting polymers (ICPs), and mixtures thereof.

ICPs are electrically conductive polymer materials. Importantly, intrinsically conducting polymers are polymer materials that have a significant conductivity without the addition, or doping, of some other material such as a noble metal. Another property of the intrinsically conductive polymers is that the are extremely corrosion resistant. This reduction in corrosion, or oxidation, is commonly referred to as redox potential. The redox potential of aluminum and iron, which are commonly found in conventional metallized coatings, is about −1.6 volts and about −0.4 volts, respectively. This causes conventional metallized coatings to oxidize the metallic surfaces to which they are applied. The uncontrolled mixture of iron oxides and -hydroxides corrodes the metal surfaces.

To prevent such an occurrence, a protective layer is often applied prior to the metallized coating.

Another aspect of the invention provides methods for controlling reaction time for in situ polymerization reaction in a mixture of alkyl-cyanoacrylate molecules (for example, monomers, including methyl-cyanoacrylate, ethyl-cyanoacrylate, propyl-cyanoacrylate, butyl-cyanoacrylate, hexyl-cyanoacrylate, and octyl-cyanoacrylate) and one or more starch, thereby providing a suitable time for forming polymer composites.

Another aspect of the invention provides composition for a molding polymer composites, wherein the polymer composite is made according to the methods described herein.

Another aspect of the invention provides composition for a molding conducting polymer composite comprising the conducting polymer composite as described above.

Unless otherwise defined, all technical and scientific terms used herein in their various grammatical forms have the same meaning as commonly understood by one of ordinary skill in the art to which this invention belongs. Although methods and materials similar to those described herein can be used in the practice or testing of the present invention, the preferred methods and materials are described below. In case of conflict, the present specification, including definitions, will control. In addition, the materials, methods, and examples are illustrative only and are not limiting.

Further features, objects, and advantages of the present invention are apparent in the claims and the detailed description that follows. It should be understood, however, that the detailed description and the specific examples, while indicating preferred aspects of the invention, are given by way of illustration only, since various changes and modifications within the spirit and scope of the invention will become apparent to those skilled in the art from this detailed description.

These and other aspects of the invention will become apparent to the skilled artisan in view of the teachings contained herein.

The invention is further disclosed and exemplified by reference to the text and drawings that follow.

### BRIEF DESCRIPTION OF THE DRAWINGS

FIG. 1. Anionic polymerization of the cyanoacrylate monomer in the presence of initiator.

FIG. 2. Reaction time as a function of starch content in the composites during in situ anionic polymerization of cyanoacrylate monomer in the presence of starch.

FIG. 3. Volume resistivity value as a function of the particle content. For comparison, conductivity curves for both potato starch and amaranth starch are shown. Relative percentages of graphite to the total amount of fillers are specified in the parentheses.

### DETAILED DESCRIPTION OF THE INVENTION

This invention provides novel electrically conductive and non-conductive polymer composite materials suitable for use as a substitute for the existing polymer composites, electrically conductive material, electromagnetic wave shielding material, heating element, antistatic material and the like. The invention also provides methods of making the electrically conductive and non-conductive polymer composite materials and molded articles, for example, constructed using wettable monomer wherein multi-component filler particles are dispersed, which is then in situ polymerized inside of any shape and size of the mold.

Some aspects and embodiments provide electrically conductive polymer composite produced from a matrix polymer composite that is composed of cyanoacrylate and starch granules and conductive filler material dispersed in it. The polymer composite manufactured from cyanoacrylate and starch works as to an insulator, however, incorporation of conductive filler materials such as graphite turns the material conductive. The degree of conductance depends on the percentage of conductive filler materials incorporated.

The term “electrically conductive polymer composite” refers to a polymer composition having a measurable level of electrical conductivity beyond that of an insulator, comprising cyanoacrylate molecule and a filler material such as starch and an electrically conductive filler material, as described herein.

The term “conductive filler” or “electro-conductive filler” refers to a material, such as graphite, carbon black, carbon fibrils or carbon fibers, nanofiber, and carbon nanotubes, which when added to a nonconductive polymer matrix produces an electrically conductive polymer composite.

Cyanoacrylate produces rapid and strong bonds between a large number of different materials by forming poly(alkylcyanoacrylate). Hydroxyl ions in common water work as an initiator. As it cures and sets, cyanoacrylate forms a tough polymer plastic. In the case when the initiators are supplied from the surface of the objects to be glued, cyanoacrylate polymerizes and sets between those two objects only when the gap between the two objects is small enough for the polymers to hold. These properties are utilized to develop a polymer composite with starches. When cyanoacrylates are blended with starches, small amount of hydroxyl ions on the surface of starches act as an initiator and the micrometer-scale gaps between starch granules satisfy the condition for forming strong bond between particles. The polymer composites produced by this procedure contain 50-65% of starches.

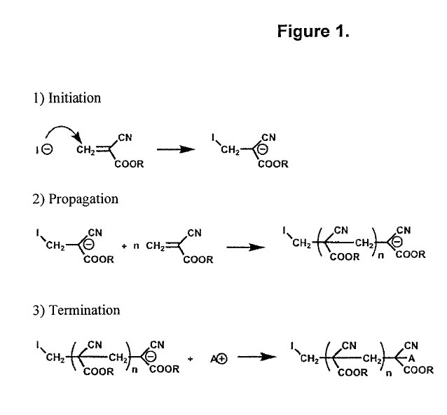

One of the reasons for the effectiveness of cyanoacrylate instant adhesives is the rapid rate of initiation by trace amounts of hydroxyl ions on the substrate surface, subsequent high rate of polymerization, and the formation of high molecular weight polymers. The stabilization of the propagating anion by the two strongly electron-withdrawing groups, —CN and —COOR, facilitates the polymerization (Klemarczyk, Polym., 39:173, 1998; Coover et al., Handbook of Adhesives, 3^{rd} ed. I. Skeist (ed), pp. 463-477, Van Nostrand Reinhold, New York, 1990). The initiation, polymerization, and termination mechanisms, with basic initiator I⁻ and cationic termination species A⁺, are outlined in FIG. 1 (see Pocius et al. (ed.) Adhesion science and engineering/Surface Chemistry and Applications, Chapter 19, Vol. 2, pp. 847-867, Amsterdam; Boston; Elsevier 2002).

Once the reaction is initiated by the hydroxyl ions of starch granules, it is highly exothermic and self-propagating and does not require application of heat. After the polymerization, the polymerized cyanoacrylate monomers act as a binder between the starch granules, which result in robust particle-filled polymer composites.

According to the present invention, materials were created for the development of polymer composite. The developed degradable biopolymer composite makes use of the peculiar properties of starch granules: 1) the surface of starch granules supplies initiator for the polymerization of alkyl cyanoacrylates; 2) the body of starch granules works as filler; and 3) the micrometer-scale gaps formed by starch granules satisfy necessary condition for the polymerization of alkyl cyanoacrylates.

According to one aspect, polymer composites can be made from cyanoacrylate monomers and starches as the non-conductive filler by in situ polymerization. The non-conductive filler materials can be made of any material as applied initiators can be supplied from their surface, for example, starches, proteins, or any substance containing moisture on the surface, or a combination thereof. The filler materials can be of any form or a mixture of forms, such as powder, flakes, particle, beads, and the like. Sizes of filler materials can vary in the μm scale, ranging from about 1 μm to about 100 μm or more.

The starch that can be utilized in the process of the invention includes, for example, potato starch, corn starch, wheat starch, rice starch, amaranth, tapioca starch, and the like. The average starch granule size ranges from about 1 to 100 μm (see Table 1). The term starch is a common name, generally applies to a white, granular or powdery, odourless, tasteless, complex carbohydrate, (C₆H₁₀O₅)ₓ, abundant in the seeds of cereal plants and in bulbs and tubers.

TABLE 1
Granule size and average size of various starches.

| Starch Source | Granule Size Range (μm) | Average size μm |
|---|---|---|
| Waxy Rice | 2-15 | 6 |
| High Amylose Corn | 4-20 | 10 |
| Corn | 5-25 | 14 |
| Cassava | 3-30 | 14 |
| Wheat | 3-35 | 7 and 20 |
| Sweet Potato | 4-40 | 19 |
| Arrowroot | 9-40 | 23 |
| Sago | 15-50 | 33 |
| Potato | 10-100 | 36 |

Starch generally refers to a polymer of glucose found as a reserve in most plants. Starch is made up of α-glucosidic bonds, which cause helix-shaped molecules. Starch includes molecules having two kinds of structures: (i) amylose (see structure 1), the C₆H₁₀O₅ groups are (linked mainly α(1-4) bonds) are arranged in a continuous but curled chain somewhat like a coil of rope; and (ii) amylopectin (see structure 2), wherein considerable side-branching of the molecule occurs.

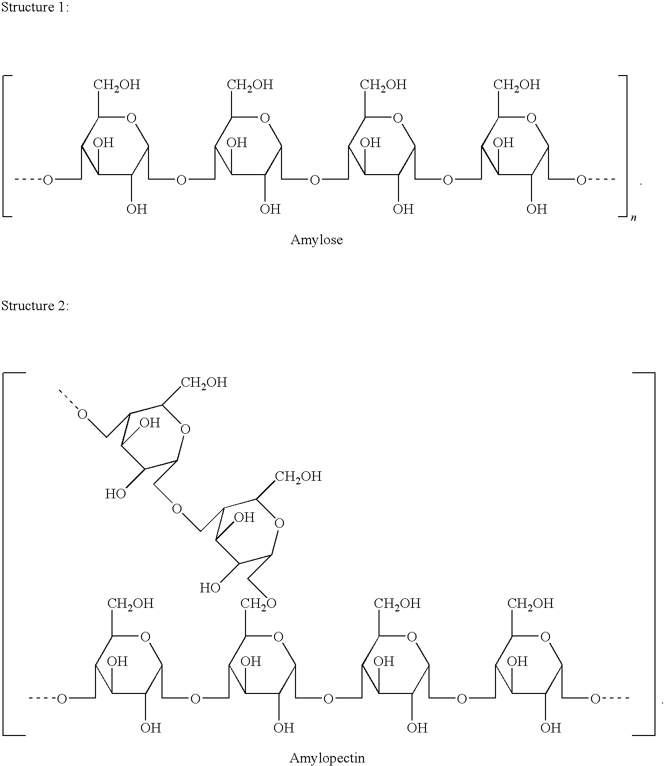

Starch also includes, starch ester, starch ether, starch succinate, and starch xanthate. Starch esters are modified starch with ester groupings like acetylated starch and starch monophosphate. Potato starch is a natural starch phosphate ester. Starch ethers are modified starch with ether groupings like hydroxypropyl-starch, cationic starch and carboxymethyl starch. Starch succinates are anionic starch esterified by succinate groups and starch xanthates are starch esterified by xanthate groups. Starch derivatives, such as through hydrolysis to yield dextrins (for example, maltodextrin), alone or in combination with starches also can be utilized according to the invention.

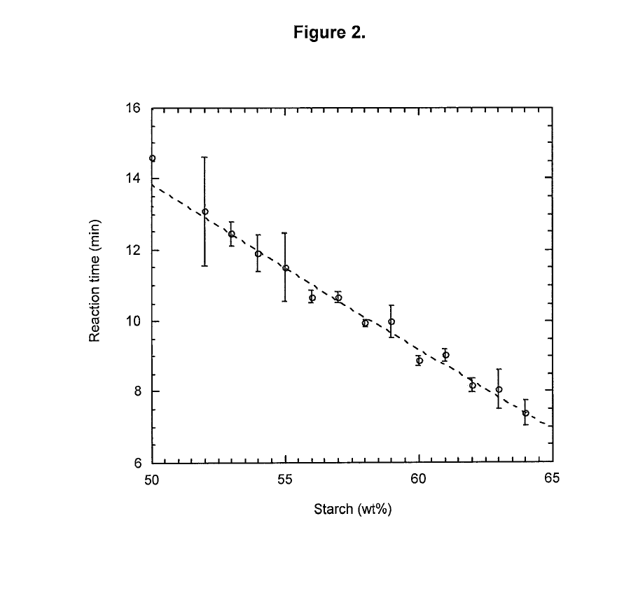

Various methods of controlling polymerization reaction rates during the production of polymer composites by in situ bulk polymerization is described, allowing polymerization ranging from 50% to 65% particle content by weight and polymerization time between 30 seconds and 30 minutes depending on the kind of starch and its moisture content. Polymerization rates are also changed by simply using different types of starch particles. This polymerization time can be further controlled by varying the moisture amount of the starch or by introducing acidic/basic additive materials. One example of the polymerization time as a function of the starch compositions (normal maize) is illustrated in FIG. 2. Generally, the polymerization rate becomes faster with increasing starch filler amount.

In another embodiment, various alkyl substituents or other substituents on a carbon of the cyanoacrylate may be used to obtain different physical properties. More specifically, the cyanoacrylate binder comprises ester chain, methyl, ethyl, propyl, butyl, hexyl, or octyl substituents.

In addition to the materials described above, at least one other adhesive substance as a polymer matrix can optionally be used as a matrix to form composite material (in combination with or without at least one cyanoacrylate).

In another embodiment, adhesive substances also include substances within the cyanoacrylate family. The cyanoacrylate family includes methyl cyanoacrylate, ethyl cyanoacrylate, n-propyl cyanoacrylate, isopropyl cyanoacrylate, n-butyl cyanoacrylate, isobutyl cyanoacrylate, n-amyl cyanoacrylate, isoamyl cyanoacrylate, 3-acetoxypropyl cyanoacrylate, 2-methoxypropyl cyanoacrylate, 3-chloropropyl cyanoacrylate, benzyl cyanoacrylate, phenyl cyanoacrylate, alkenyl cyanoacrylate, alkoxyalkyl 2-cyanoacrylates, fluorinated 2-cyanoacrylates, carbalkoxyalkyl cyanoacrylates, etc.

The above-listed members of the cyanoacrylate family, as well as other members of the cyanoacrylate family, known in the art, and other adhesive substances that fall within the scope of this invention and are not listed above, also can be used. The adhesive substances described herein also can be used in vivo depending upon acceptable toxicity and other properties for a given application.

The produced polymer composite has one or more of the following capabilities or properties:

1) Polymerize without catalyst;

2) Polymerize at room temperature;

3) Strong binding with starch;

4) Hydrophobic surface—Stable upon contact with water;

5) Degradable—Except conductive fillers;

6) Can be molded to any shape;

7) Quick setting (about 2-20 minutes, adjustable);

8) Good mechanical strength;

9) Stand high temperature (−150° C.);

10) Easy repairing;

11) Easy incorporation of strong fibers to improve mechanical properties;

12) Easy coloring—Starches are easily colored;

13) Machineable;

14) Adjustable brittleness; and

15) No requirement for post-treatment such as drying, annealing to stabilize the polymerized products.

Conductive filler materials generally have volume resistivity values from about 10⁻³ Ωcm to 10⁻⁶ Ωcm depending on the materials, while insulating materials generally have resitivity of greater than about 10¹³ Ωcm to 10¹⁶ Ωcm. Accordingly, the resistivity of the composite materials comprised of insulator matrices and conductive fillers can range the resistivity value in between. For example, the resistivity of the polymer composites obtained from graphite/potato starch/ethyl cyanoacrylate composition of 25/25/50 by weight reaches to 100 Ωcm.

Graphite particles used in this invention has particle size of <20 μm. But, different particle size or other types of the graphite particles for example graphite nanofiber, exfoliated graphite, and graphite flakes can be used.

The conductive filler used in this embodiment is graphite particles but other types of conductive filler particles such as carbon black, carbon fiber, and carbon nanofiber etc. can be used solely or as a mixture.

The reaction mixture that is comprised of starch, cyanoacrylate, and conductive filler can be injected or cast into any appropriate mold. Solid polymer networks are formed in the mold after monomers are in situ polymerized. Therefore, the polymer composites of the present invention can be molded in any form or shape. Examples include cylinder, sphere, hexagonal, any other building block, and even much defined structures. These composites, which may have a complex shape, possess uniform physical properties through the entire body. As an example, a cylinder type specimen have been molded and used to determine the volume resistivity of the specimen.

Theoretically, in the conducting composites where conductive particles are dispersed in certain types of matrices, the conductivity is a complicated function of the filler amount, rather than being a linear function of loading. The conductivity is initially insensitive to loadings. Then, it rises dramatically as the percolation threshold is reached. At this percolation threshold, particles of fillers come into contact with each other, leading to the formation of a continuous conducting network.

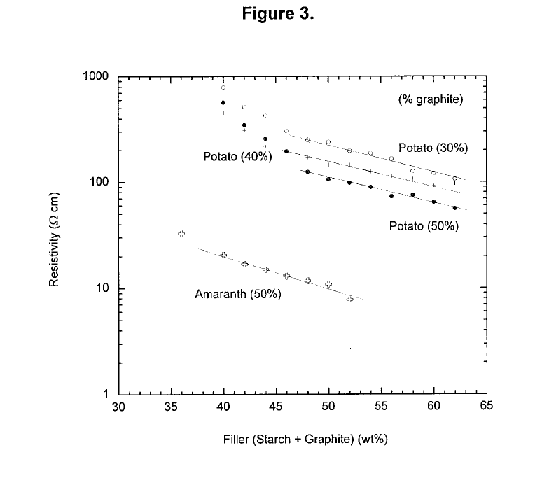

The volume resistivity of sample composites shown in FIG. 3 reveals the expected conductance behavior exhibiting percolation threshold at low loading of the conductive filler followed by the monotonous decrease in the resistivity with further increase in conductive filler particles. The steeper increase in resistivity at lower than 45% solid particles indicates the existence of percolation threshold in that region.

In general, even if the conductive particles are contacting each other, there is still a particle-particle contact resistance due to electrons being forced through small contact area, which can lead to lower conductivity of the composites in several orders of magnitude than that of the pure conductive filler. This particle-particle contact resistance (R_{cr}) is mathematically modeled by the equation:

R_{cr}=ρ₀/d

Where ρ₀ is the resistivity of the filler and d is the contact area diameter (see Ruschau et al., J. Appl. Phys. 72: 953, 1992). This model explains the monotonous decrease in the resistivity with further increase in conductive filler particles.

Since the polymer matrix is an insulator, the overall resistance is increased by the presence of the matrix. This is due to the formation of thin polymer film coating on the outside of the particles in the system with good polymer-filler adhesion though there is a tunneling conduction through the insulating regions of polymer matrix which separate conductive particles if the film thickness is less than 10 nm.

Another interesting feature of this embodiment is that employment of different type of starch granules greatly changes final conductivity of the composite materials. For example, electrical resistivity of the composites decreases approximately one order of magnitude when the employed starch is changed from potato starch to amaranth starch at the same particle content (50 wt %) as is shown in FIG. 3.

The use of a different electrically conductive material, including different sized and shaped conductive material in the composition can provide a way to control chemical, physical, electrical, thermal, and mechanical properties of the composites. For example, the use of metallic materials as a filler particle can alter the electrical resistivity, magnetic property, and physical property such as density and mechanical strength.

The most promising aspect of this invention is that additional processing of the materials such as thermal melting or dissolution in solvent is not necessary to obtain the products for commercial use, which most of the conventional polymers have to go through.

The possible application of this invention includes electromagnetic radiation shielding materials, heating element, and antistatic material, resistors, transducers, assembling components of electronic devices, medicinal goods, and articles for technical purposes.

According to another embodiment of the invention, the volume resistivity of the conducting composites could actually be controlled by manipulating the composition between fillers, for example between starch and graphite.

It is to be understood that the description, specific examples and data, while indicating exemplary embodiments, are given by way of illustration and are not intended to limit the present invention. Various changes and modifications within the present invention will become apparent to the skilled artisan from the discussion, disclosure and data contained herein, and thus are considered part of the invention.

1. A method of making a polymer composite comprising:
a) mixing alkyl-cyanoacrylate molecules with one or more starch molecules; and
b) allowing polymerization of the mixture, thereby forming a polymer composite.

2. The method of claim 1, wherein the starch is a filler.

3. A method of making a conducting polymer composite comprising a base matrix, wherein the matrix is a polymer composite made according to claim 1.

4. A conducting polymer composite comprising a conducting filler material dispersed in a matrix material in an amount which is at about or just exceeds the percolation threshold and sufficient to generate a continuous conducting network in the minor phase material.

5. The conducting polymer composite of claim 4, wherein the conducting filler is an electro-conductive fillers selected from the group consisting of graphite, carbon black, carbon fiber, carbon nanofiber, carbon nanotubes, intrinsically conducting materials, and mixtures thereof.

6. A method for controlling reaction time for polymerization reaction in a mixture of alkyl-cyanoacrylate molecules and starch molecules, thereby providing a suitable time for forming polymer composites.

7. A composition for a molding polymer composites, wherein the polymer composite is made according to claim 1.

8. A composition for a molding conducting polymer composite comprising the conducting polymer composite according to claim 4.

9. The methods according to claim 1, wherein the polymerization is carried out in situ.

10. The methods according to claim 1, wherein the alkyl-cyanoacrylate molecules are monomers.

11. The methods according to claim 1, wherein the alkyl-cyanoacrylate molecules are selected from the group consisting of methyl-cyanoacrylate, ethyl-cyanoacrylate, propyl-cyanoacrylate, butyl-cyanoacrylate, hexyl-cyanoacrylate, and octyl-cyanoacrylate.

12. The methods according to claim 1, wherein the starch is a potato starch, corn starch, wheat starch, rice starch, amaranth starch, tapioca starch, or the like.
